(19) United States
(12) Patent Application Publication
(10) Pub. No.: US 2022/0348381 A1
(43) Pub. Date: Nov. 3, 2022

(54) Foldable Cup And Spray Cup

(71) Applicant: Tai Zhou Luxi Tools Co., Ltd., Wenling (CN)

(72) Inventor: Xinggang Pan, Wenling (CN)

(21) Appl. No.: 17/665,055

(22) Filed: Feb. 4, 2022

(30) Foreign Application Priority Data
Apr. 30, 2021 (CN) 202120938321.1
Dec. 8, 2021 (CN) 202123092567.0

(51) Int. Cl. B65D 21/08; B67C 11/02; B65D 51/24; B05C 5/02

(52) U.S. Cl. CPC B65D 21/086; B67C 11/02; B65D 51/242; B05C 5/02

(57) ABSTRACT

Disclosed is a foldable cup and a spray cup, comprising: a cup opening, a cup body connected with the cup opening, and a discharge port disposed at the lower portion of the cup body, wherein the cup body is made of a flexible material, which, after being folded, shrinks the overall cup size. The disclosed cup body is made of a foldable, flexible material, such that the cup size can be shrunk to facilitate storage.

### CROSS-REFERENCE TO RELATED APPLICATION(S)

This application claims priority to Chinese Application No. 202120938321.1 filed on Apr. 30, 2021, and Chinese Application No. 202123092567.0 filed on Dec. 8, 2021. The entire contents of above identified applications are hereby incorporated by reference.

### TECHNICAL FIELD

Embodiments of the present disclosure relate to a cup and a spray cup, and more specifically relate to a container for holding paint, coating, or banana oil.

### BACKGROUND

A conventional cup mainly assumes a structure of funnel container or storage can, for holding corrosive liquid such as paint, coating, or banana oil. In the present disclosure, the cup may serve as a storage can or funnel used in spray equipment. Conventional funnel structures or storage-can structures are all made of a rigid material with a relatively large size, such that they are inconvenient to store.

### SUMMARY

To overcome the above and other drawbacks of conventional technologies, embodiments of the present disclosure provide a foldable cup with a shrinkable size and easy to store, and a foldable spray cup with a shrinkable size and easy to store.

A foldable cup provided according to the present disclosure comprises: a cup opening, a cup body connected with the cup opening, and a discharge port disposed at the lower portion of the cup body, wherein the cup body is made of a flexible material, which, after being folded, shrinks overall size of the cup.

The foldable cup provided according to the present disclosure further has the following additional technical features:

The cup opening has a cylindrical structure made of a rigid material, wherein the cup body is folded towards the inside of the cup opening so as to receive the cup body in the cup opening.

The cup body further comprises a plurality of segments of a flexible connected portion made of a flexible material and a plurality of segments of a rigid connecting portion made of a rigid material, wherein the respective segments of the flexible connected portion are connected by the rigid connecting portion.

The cup body further comprises a plurality of rigid connecting rings made of a rigid material, wherein the plurality of rigid connecting rings are arranged at intervals on the surface of the cup body.

Furthermore, the discharge port is made of a rigid material, the discharge port being in communicative connection with the bottom of the cup body.

Furthermore, a semi-lid is provided on top of the cup opening.

Furthermore, a handle is provided on the cup opening.

Embodiments of the present disclosure further provide a foldable spray cup, comprising: a cup body, and a cup lid connected with the cup body, wherein a discharge port is provided at the lower portion of the cup body, and the cup body is partially made of a flexible material such that the cup body, after being folded, shrinks the overall spray cup size.

The foldable spray cup provided according to the present disclosure further has the following additional technical features:

The cup body further comprises an upper cup body connected piece made of a rigid material, a lower cup body connected piece made of a rigid material, and a flexible connecting piece made of a flexible material, wherein the flexible connecting piece is configured to connect the upper cup body connected piece and the lower cup body connected piece.

The discharge port is disposed on the lower cup body connected piece.

The flexible connecting piece is provided with volume scale reads.

The discharge port is further provided with an insert.

The foldable spray cup further comprises at least one support structure, wherein the support structure comprises an upper supporting seat, a lower supporting seat, and a supporting bar, wherein the upper supporting seat is disposed on the upper cup body connected piece, the lower supporting seat is disposed on the lower cup body connected piece, and the supporting bar connects the upper supporting seat and the lower supporting seat.

The foldable cup and the spray cup provided according to the present disclosure have the following advantages over conventional technologies: since the cup body of the present disclosure adopts a foldable, flexible material, the size of the cup may be shrunk to facilitate storage.

### BRIEF DESCRIPTION OF DRAWINGS

FIG. 1 is a front view of a cup according to the present disclosure;

FIG. 2 is a front view of the folded cup according to the present disclosure;

FIG. 3 is a stereoscopic view of FIG. 2.

FIG. 4 is a front view of a cup according to another embodiment of the present disclosure.

FIG. 5 is a front view of a cup according to a further embodiment of the present disclosure.

FIG. 6 is a front view of a spray cup according to the present disclosure;

FIG. 7 is a front view of a spray cup with a support structure according to the present disclosure.

FIG. 8 is a half sectional view of a spray cup according to the present disclosure.

FIG. 9 is a front view of the folded spray cup according to the present disclosure.

FIG. 10 is a front view of a spray cup according to another embodiment of the present disclosure.

FIG. 11 is a front view of a spray cup according to a further embodiment of the present disclosure.

### DETAILED DESCRIPTION

Hereinafter, the present disclosure will be described in detail through embodiments with reference to the accompanying drawings so as to make the solutions of the present disclosure much clearer. The description below is only illustrative, not for limiting applications or uses of the present disclosure. It is understood that throughout the drawings, same or corresponding reference numerals indicate same or corresponding parts or features.

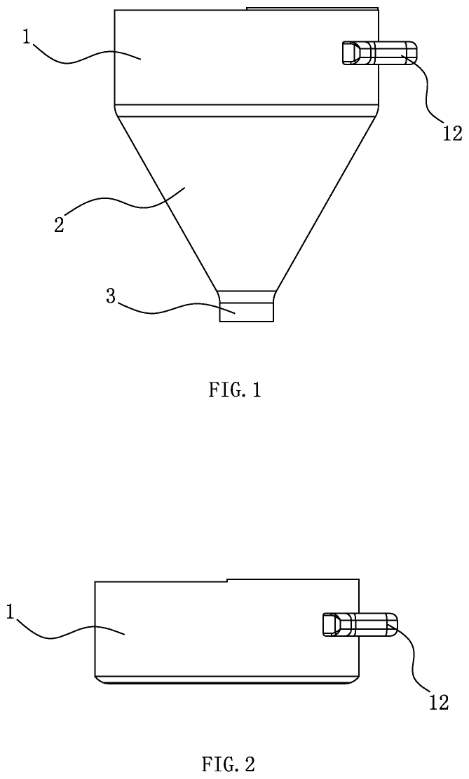

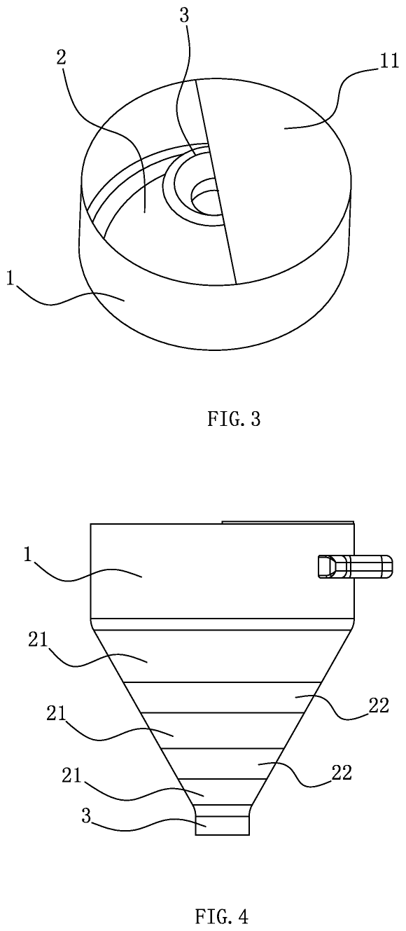

As illustrated in FIGS. 1 to 3, a foldable cup provided according to a first embodiment of the present disclosure comprises: a cup opening 1, a cup body 2 connected with the cup opening 1, and a discharge port 3 disposed at the lower portion of the cup body 2, wherein the cup body 2 is made of a flexible material, which, after being folded, shrinks the overall cup size. The cup body 2 of the present disclosure may be of a conventional flexible material, e.g., soft plastics, rubber, etc. The flexible material has a rigidity but can be folded, such that the flexible material enables adjustment of the thickness of the cup body 2 to meet relevant requirements. Meanwhile, the flexible material is subjected to anti-corrosion processing, such that the entirety of the cup body 2 can resist against corrosive liquid such as paint, coating, and banana water. For example, an anti-corrosion layer is applied to the inner wall of the cup body of the present disclosure. The cup body 2 of the present disclosure is foldable and thus can shrink the size to facilitate storage. The cup according to the present disclosure may be a funnel, or a storage can for use with a spray gun.

In the embodiment of the present disclosure illustrated in FIG. 1 to FIG. 3, the cup opening 1 has a cylindrical structure made of a rigid material, and the cup body 2 is folded towards the inside of the cup opening 1 so that the cup body 2 is received in the cup opening 1. In the present disclosure, the cup body 2 is pushed forcibly into the cup opening 1 such that the cup body 2 is folded into the cup opening 1, thereby shrinking the size.

In the embodiment illustrated in FIGS. 1 to 3, the discharge port 3 is made of a rigid material, and the discharge port 3 is in communicative connection with the bottom of the cup body 2. The discharge port 3 is made of a rigid material. As the discharge port 3 has a rigidity, it is not easily deformed, thereby facilitating discharge as well as connection with other components.

In the embodiment illustrated in FIGS. 1 to 3, a semi-lid 11 is provided on top of the cup opening 1. The semi-lid 11 refers to a half lid, playing a role of preventing splashing. A handle 12 is provided on the cup opening 1. The handle 12 may be provided at a side face of the cup opening 1 or disposed on top of the cup opening 1, mainly facilitating use of the cup. The handle 12 in the present disclosure may come in a variety of forms, mainly facilitating grip.

FIG. 4 illustrates another embodiment of the present disclosure, wherein the cup body 2 comprises a plurality of segments of a flexible connected portion 21 made of a flexible material and a plurality of segments of a rigid connecting portion 22 made of a rigid material, wherein the respective segments of the flexible connected portion 21 are connected by the rigid connecting portion 22. The alternate layout of the plurality of segments of the flexible connected portion and the plurality of segments of the rigid connecting portion not only enables foldability of the cup body 2, but also may enhance strength of the cup body 2, such that the cup body is not easily deformed, preventing collapse of the cup. The other structures of this embodiment are identical to the first embodiment, which are not detailed here.

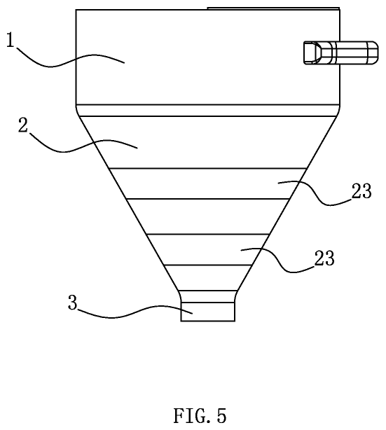

FIG. 5 illustrates a further embodiment of the present disclosure, wherein the cup body 2 further comprises a plurality of rigid connecting rings 23 made of a rigid material, wherein the plurality of rigid connecting rings 23 are arranged at intervals on the surface of the cup body 2. In this embodiment, the rigid connecting rings 23 partition the cup body 2 into multiple flexible segments and rigid segments, wherein the flexible segments facilitate folding of the cup body 2, while the rigid segments enhance cup body strength such that the cup body is not easily collapsed. The other structures of this embodiment are identical to the first embodiment, which are not detailed here.

The cup in the present disclosure may have a round structure, or a square structure, or another shape. In this embodiment, the cup body 2 has a conical shape, facilitating folding.

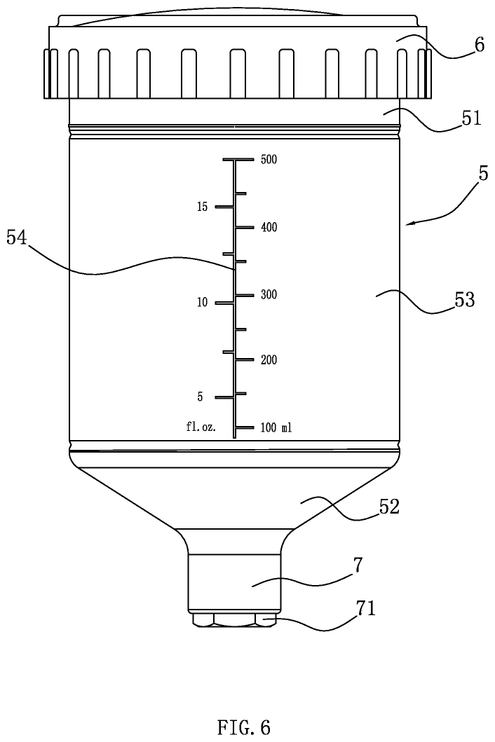

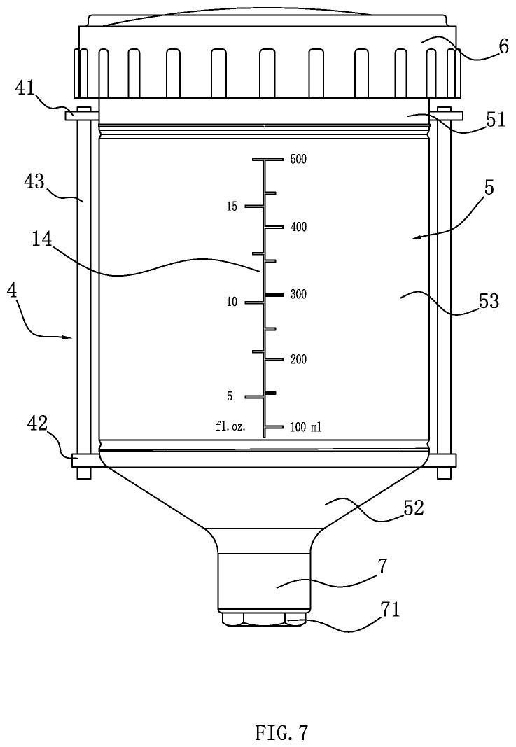

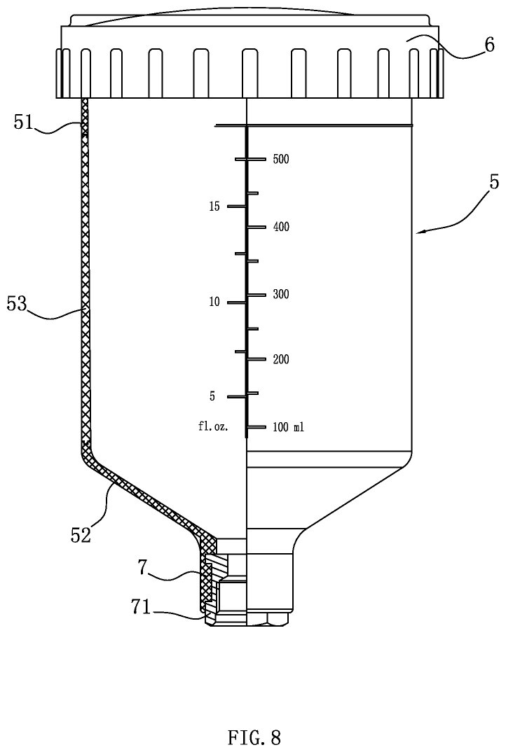

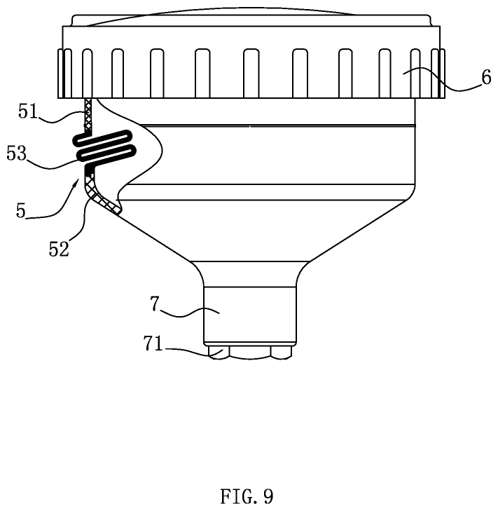

FIGS. 6-9 illustrates a foldable spray cup according to the present disclosure, comprising: a cup body 5, and a cup lid 6 connected with the cup body 5, wherein a discharge port 7 is provided at the lower portion of the cup body. The cup body 5 is partially made of a flexible material such that the cup body 5, after being folded, shrinks the overall spray cup size. The cup body 5 of the present disclosure may be of a conventional flexible material, e.g., soft plastics, rubber, etc. The flexible material has a rigidity but can be folded, such that the thickness of the cup body 5 may be adjusted to meet relevant requirements. Meanwhile, the flexible material is subjected to anti-corrosion processing, such that the entirety of the flexible material can resist against corrosive liquids such as paint, coating, and banana water. For example, an anti-corrosion layer is applied to the inner wall of the cup body according to the present disclosure. The cup body 5 of the present disclosure is foldable and thus can shrink the size to facilitate storage. The spray cup according to the present disclosure may serve as a storage can for use with a spray gun.

In the embodiment illustrated in FIGS. 6-9, the cup body 5 further comprises an upper cup body connected piece 51 made of a rigid material, a lower cup body connected piece 52 made of a rigid material, and a flexible connecting piece 53 made of a flexible material, wherein the flexible connecting piece 53 is configured to connect the upper cup body connected piece 51 and the lower cup body connected piece 52. The upper cup body connected piece 51 and the lower cup body connected piece 52 play a supporting role. The flexible connecting piece 53 can be folded to shrink the height of the cup body 5. The upper cup body connected piece 51 and the lower cup body connected piece 52 are of a metal material or a rigid corrosion-resistive plastic material.

In the embodiment illustrated in FIGS. 6-9, the discharge port 7 is further provided on the lower cup body connected piece 52. A feed port is formed on the upper cup body connected piece 51, and the cup lid 6 is mounted on the upper cup body connected piece 51 to cover the feed port. The discharge port 7 is connected with a spray gun. An insert 71 is provided at the discharge port 7, wherein the insert 71 is made of metal, serving as a connector to connect with the spray gun. The insert 71 facilitates connection and offers a better sealing effect.

In the embodiment illustrated in FIGS. 6-9, the foldable spray cup further comprises at least one support structure 4, wherein the support structure 4 comprises an upper supporting seat 41, a lower supporting seat 42, and a supporting bar 43, the upper supporting seat 41 is disposed on the upper cup body connected piece 51, the lower supporting seat 42 is disposed on the lower cup body connected piece 52, and the supporting bar 43 connects the upper supporting seat 41 and the lower supporting seat 42. The support structure 4 is configured to support the cup body 5, such that the cup body 5 does not collapse during operating; therefore, the support structure 4 plays a fixing role. Thanks to the support structure 4, the flexible connecting piece 53 may be made of a relatively flexible material or may adopt a relatively thin structure, thereby facilitating folding.

In the embodiment illustrated in FIGS. 6 to 9, volume scale reads 54 are further provided on the flexible connecting piece 53. The volume scale reads 54 facilitate observing the volume.

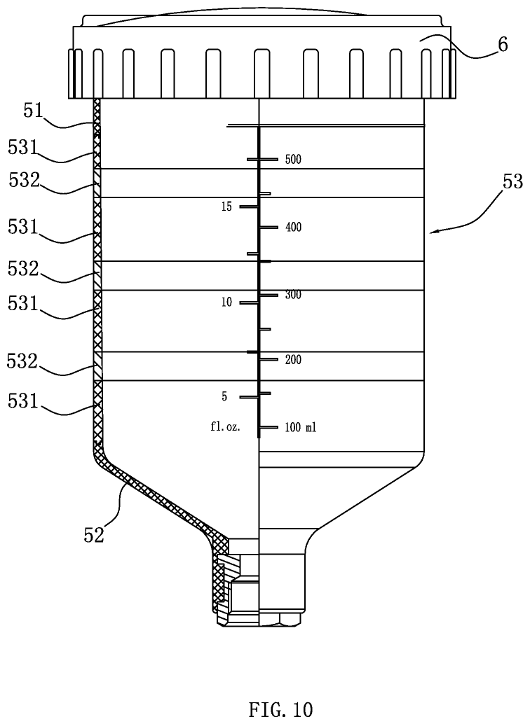

FIG. 10 illustrates a still further embodiment of the present disclosure, wherein the flexible connecting piece 53 comprises a plurality of flexible connected segments 531 made of a flexible material and a plurality of rigid connecting segments 532 made of a rigid material, wherein the respective flexible connected segments 531 are connected by the rigid connecting segments 532. The alternate layout of the flexible connected segments and the rigid connecting segments in the embodiment of the present disclosure not only enables foldability of the cup body 5, but also may enhance strength of the cup body 5, such that the cup body is not easily deformed, preventing collapse of the spray cup. The other structures of this embodiment are identical to the first embodiment, which are not detailed here.

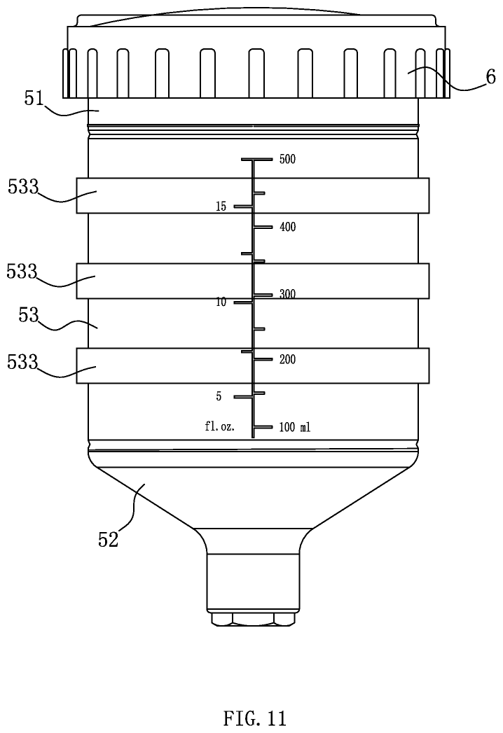

FIG. 11 illustrates a still further embodiment of the present disclosure, the flexible connecting piece 53 further comprises a plurality of rigid connecting rings 533 made of a rigid material, wherein the plurality of rigid connecting rings 533 are arranged at intervals on the surface of the flexible connecting piece 53. In this embodiment, the rigid connecting rings 533 partition the flexible connecting piece 53 into multiple flexible segments and rigid segments, wherein the flexible segments facilitate folding of the cup body 5, while the rigid segments enhance cup body strength, such that the cup body is not easily collapsed. The other structures of this embodiment are identical to the first embodiment, which are not detailed here.

In view of the above, the contents provided above are only embodiments of the present disclosure, which are only for illustrating the principle of the present disclosure, not for limiting the protection scope of the present disclosure. Any modifications, equivalent substitutions, and improvements within the spirit and principle of the present disclosure should be included within the protection scope of the present disclosure.

What is claimed is:

1. A foldable cup, comprising: a cup opening, a cup body connected with the cup opening, and a discharge port disposed at the lower portion of the cup body, wherein the cup body is made of a flexible material, which, after being folded, shrinks an overall size of the foldable cup.

2. The foldable cup according to claim 1, wherein the cup opening has a cylindrical structure made of a rigid material, wherein the cup body is folded towards the inside of the cup opening so as to receive the cup body in the cup opening.

3. The foldable cup according to claim 1, wherein the cup body further comprises a plurality of segments of a flexible connected portion made of a flexible material and a plurality of segments of a rigid connecting portion made of a rigid material, wherein the respective segments of the flexible connected portion being connected by the rigid connecting portion.

4. The foldable cup according to claim 1, wherein the cup body further comprises a plurality of rigid connecting rings made of a rigid material, wherein the plurality of rigid connecting rings are arranged at intervals on a surface of the cup body.

5. The foldable cup according to claim 1, wherein the discharge port is made of a rigid material, the discharge port being in communicative connection with the bottom of the cup body.

6. The foldable cup according to claim 1, wherein a semi-lid is provided on top of the cup opening, and a handle is provided on the cup opening.

7. A foldable spray cup, comprising: a cup body, and a cup lid connected with the cup body, wherein a discharge port is provided at the lower portion of the cup body, and the cup body is partially made of a flexible material such that the cup body, after being folded, shrinks an overall size of the foldable spray cup.

8. The foldable spray cup according to claim 7, wherein the cup body further comprises an upper cup body connected piece made of a rigid material, a lower cup body connected piece made of a rigid material, and a flexible connecting piece made of a flexible material, wherein the flexible connecting piece is configured to connect the upper cup body connected piece and the lower cup body connected piece.

9. The foldable spray cup according to claim 8, further comprising at least one support structure, wherein the support structure comprises an upper supporting seat, a lower supporting seat, and a supporting bar, wherein the upper supporting seat is disposed on the upper cup body connected piece, the lower supporting seat is disposed on the lower cup body connected piece, and the supporting bar connects the upper supporting seat and the lower supporting seat.

10. The foldable spray cup according to claim 8, wherein the discharge port is disposed on the lower cup body connected piece; the flexible connecting piece is provided with volume scale reads; and the discharge port is further provided with an insert.
